(19) United States
(12) Patent Application Publication
(10) Pub. No.: US 2007/0213900 A1
(43) Pub. Date: Sep. 13, 2007

(54) Method and Apparatus for Preventing Rollover of a Vehicle

(75) Inventor: Markus Raab, Kirchardt (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/583,973

(22) PCT Filed: Dec. 22, 2004
(86) PCT No.: PCT/EP04/14593

§ 371 Date: May 22, 2007

(30) Foreign Application Priority Data
Dec. 23, 2003 (DE) 103 60 732.3

(51) Int. Cl. B60G 17/018

(52) U.S. Cl. 701/38; 701/41; 701/37

(57) ABSTRACT

A method and apparatus for preventing roll in a vehicle utilizing a detection device which determines an actual yaw rate of the vehicle, an evaluation unit which determines a setpoint value and a threshold value for the yaw rate, and a control device for controlling vehicle units that influence the dynamics of the vehicle. The evaluation unit controls the vehicle units, by comparing the determined actual value of the yaw rate variable with the determined setpoint value; such that the actual value of the yaw rate variable assumes the determined setpoint value. If the setpoint value exceeds the threshold value, the vehicle the evaluation unit limits the determined setpoint value to the determined threshold value. According to the invention, the evaluation unit determines the threshold value of the yaw rate variable as a function of a threshold value of a roll angle variable which describes a roll angle of the vehicle.

This application claims the priority of German patent document 103 60 732.3, filed Dec. 23, 2003 (PCT International Application No. PCT/EP2004/014593, filed Dec. 22, 2004), the disclosure of which is expressly incorporated by reference herein.

### BACKGROUND AND SUMMARY OF THE INVENTION

The invention relates to a method and apparatus for preventing roll in a vehicle, in which a detection device determines an actual value of a yaw rate variable describing the yaw rate of the vehicle, an evaluation unit determines a setpoint value of the yaw rate variable and a threshold value of the yaw rate variable that is suitable for limiting the setpoint value for avoiding rollover of the vehicle, and a control device controls vehicle units that influence the longitudinal and/or transversal dynamics of the vehicle. The evaluation unit controls the vehicle units, based on a comparison between the determined actual value of the yaw rate variable and the determined setpoint value of the yaw rate variable, in such a way that the determined actual value of the yaw rate variable assumes the determined setpoint value of the yaw rate variable. In the event that the setpoint value of the yaw rate variable exceeds the threshold value of the yaw rate variable, to avoid rollover of the vehicle the evaluation unit limits the determined setpoint value of the yaw rate variable to the determined threshold value of the yaw rate variable.

Such a stabilization system for increasing the roll stability of a vehicle is disclosed in German patent document DE 198 30 189 A1. The vehicle has a yaw movement regulating device which in a known manner regulates the yaw rate of the vehicle to a setpoint value that depends on the driver's specifications, by intervening in the braking means and/or drive means of the vehicle. In this manner, the threshold value for avoiding rollover of the vehicle is limited to a physically meaningful value. The physical considerations take into account not only the coefficient of friction conditions of the roadway surface, but also the critical transverse acceleration which when reached causes the vehicle to roll.

One object of the invention is to provide an alternative stabilization system for increasing the roll stability of a vehicle, which allows a reliable and direct assessment of the instantaneous roll state of the vehicle.

This and other objects and advantages are achieved by the method and apparatus according to the invention for preventing roll in a vehicle, which includes a detection device for determining an actual value of a yaw rate variable that describes the yaw rate of the vehicle, and an evaluation unit for determining a setpoint value of the yaw rate variable and a threshold value of the yaw rate variable that is suitable for limiting the setpoint value for avoiding rollover of the vehicle. There is also a control device for controlling vehicle units that influence the longitudinal and/or transversal dynamics of the vehicle. The evaluation unit controls the vehicle units, based on a comparison between the determined actual value of the yaw rate variable and the determined setpoint value of the yaw rate variable, in such a way that the determined actual value of the yaw rate variable assumes the determined setpoint value of the yaw rate variable.

In the event that the setpoint value of the yaw rate variable exceeds the threshold value of the yaw rate variable, to avoid rollover of the vehicle the evaluation unit limits the determined setpoint value of the yaw rate variable to the determined threshold value of the yaw rate variable. According to the invention, the evaluation unit determines the threshold value of the yaw rate variable as a function of a threshold value of a roll angle variable which describes a roll angle of the vehicle.

The values which the roll angle variable can assume in the course of travel of the vehicle span an n-dimensional (n ε [symbol] ) array which may be divided into two n-dimensional subarrays, of which a first subarray includes all values of the roll angle variable that result in a roll-stable state of the vehicle, whereas a second subarray includes all values of the roll angle variable for which the vehicle assumes a rolling state. Thus, due to the unambiguous assignment to one of the two subarrays, the roll angle variable allows a reliable and direct assessment of the instantaneous roll state of the vehicle. Accordingly, to prevent a rollover the threshold value of the roll angle variable is selected such that it is an element of the first subarray. The values of the roll angle variable included in the two subarrays may be present either in the form of discrete single values or in the form of a continuum. The roll angle variable in particular is the tipping angle of the vehicle which describes a rotation of the vehicle about a tipping axis oriented in the longitudinal direction of the vehicle.

It is advantageous for the threshold value of the roll angle variable to be a part of the intersection formed by the two subarrays, so that the threshold value of the roll angle variable determined by the evaluation unit characterizes a defined transition between a roll-stable state and a rolling state of the vehicle. In this case, the threshold value of the yaw rate variable may be determined in such a way that the setpoint value of the yaw rate variable is limited by interventions in the vehicle units only when the instantaneous roll state of the vehicle actually makes this necessary. A significant increase in the comfort level for both the driver and passengers is thus achieved.

The evaluation unit determines the setpoint value of the yaw rate variable, for example as a function of a determined steering angle variable that describes the steering angle which can be set at the steerable wheels of the vehicle, and/or as a function of a longitudinal speed variable that describes the longitudinal speed of the vehicle, it being possible to use a simple and, in most cases, adequate single-track vehicle model (see “Bosch, Kraftfahrtechnisches Taschenbuch” [Automotive Engineering Handbook], Vieweg-Verlag, 23rd Edition, pp. 707ff.).

For reliable detection of the instantaneous roll state of the vehicle, the evaluation unit determines the threshold value of the yaw rate variable as a function of variables that characterize the load state and/or geometric characteristics and/or body characteristics of the vehicle.

The load state of the vehicle may be characterized accurately by indicating the position of center of gravity and/or the mass of the vehicle. Accordingly, the variables that characterize the load state of the vehicle include a position of center of gravity variable which describes the location of the center of gravity of the vehicle, and/or a mass variable which describes the mass of the vehicle.

With regard to the geometric and body characteristics of the vehicle, primarily the track width, the position of center of roll, and the roll resistance of the body of the vehicle have a significant influence on the roll behavior of the vehicle. It is therefore advantageous for the variables that characterize the geometric characteristics of the vehicle to include a track width variable which describes the track width of the vehicle, and/or a position of center of roll variable that describes the location of the center of roll of the vehicle. The same applies for the variables that characterize the body characteristics of the vehicle, which preferably include a roll resistance variable which describes the roll resistance of the vehicle.

It is advantageous for the evaluation unit to determine the position of center of gravity variable and/or the mass variable while and/or before the vehicle starts to travel, so that in each case the values for the position of center of gravity variable and/or the mass variable, which correspond to the instantaneous load state of the vehicle, are available for determining the threshold value of the yaw rate variable.

The position of center of gravity variable and/or the mass variable may be accurately determined as a function of variables that characterize the state of motion of the vehicle, and/or as a function of the temporal response of at least one of these variables. Particularly good accuracy is achieved when the variables that characterize the state of motion of the vehicle include a tipping angle variable which describes the tipping angle of the vehicle, and/or a pitch angle variable which describes the pitch angle of the vehicle. The tipping angle variable and/or the pitch angle is determined, for example, by evaluating the deflection paths which occur at the wheel suspension units of the vehicle, or by use of appropriate angle sensors.

To reduce the computing demands placed on the evaluation unit, as an alternative to the previously described determination of the position of center of gravity variable and/or mass variable it is possible in each case to store a fixed, predetermined value for the position of center of gravity variable and/or the mass variable in the evaluation unit. The values stored in the evaluation unit are specified in such a manner that even unfavorable load states of the vehicle are taken into account which cannot result in a rollover of the vehicle (“worst case”).

Furthermore, for reliable determination of the instantaneous roll state of the vehicle the evaluation unit can determine the threshold value of the yaw rate variable as a function of variables that characterize the transverse dynamics of the vehicle. In this regard the transverse acceleration acting on the vehicle is of particular importance, so that it is advantageous for the variables to include a transverse dynamics variable which describes the transverse acceleration acting on the vehicle.

It is possible to achieve an exact and timely (“low-delay”) influence of the actual value of the yaw rate variable, as defined by the setpoint value of the yaw rate variable, in particular when the vehicle units are drive means for providing propulsion which acts on the vehicle, and/or braking means for braking the wheels of the vehicle, and/or steering means for influencing the steering of the vehicle. The drive means includes, among other components, the engine, transmission, and transmission coupling for the vehicle, while the braking means includes wheel braking devices associated with the wheels of the vehicle. The braking means preferably is designed so that the wheels of the vehicle may each be braked independently, thereby enabling the actual value of the yaw rate variable to be influenced in a particularly accurate manner. The steering means is provided in a known manner for influencing the steering angle which can be set at the steerable wheels of the vehicle. Intervention in the steering means of the vehicle allows the actual value of the yaw rate variable to be influenced in a particularly low-delay and thus convenience-prioritized manner. The braking means, drive means, and/or steering means may be controlled by the evaluation unit via a control device for performing interventions independently of the driver.

The detection device, evaluation unit, and control device are advantageously components of an electronic stability program (ESP) system, so that in particular the stability system according to the invention may be converted or retrofitted economically and relatively easily by modifying a conventional ESP system, i.e., one that is already present in the vehicle.

To indicate to the driver the presence of a critical roll state of the vehicle, the evaluation unit provides controllable driver information means for sending optical and/or acoustic driver information, and the evaluation unit causes the optical and/or acoustic driver information to be sent in conjunction with the control of the vehicle units.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematically illustrated exemplary embodiment of the device according to the invention; and

FIG. 2 is an exemplary embodiment of the method according to the invention in the form of a flow diagram.

### DETAILED DESCRIPTION OF THE DRAWINGS

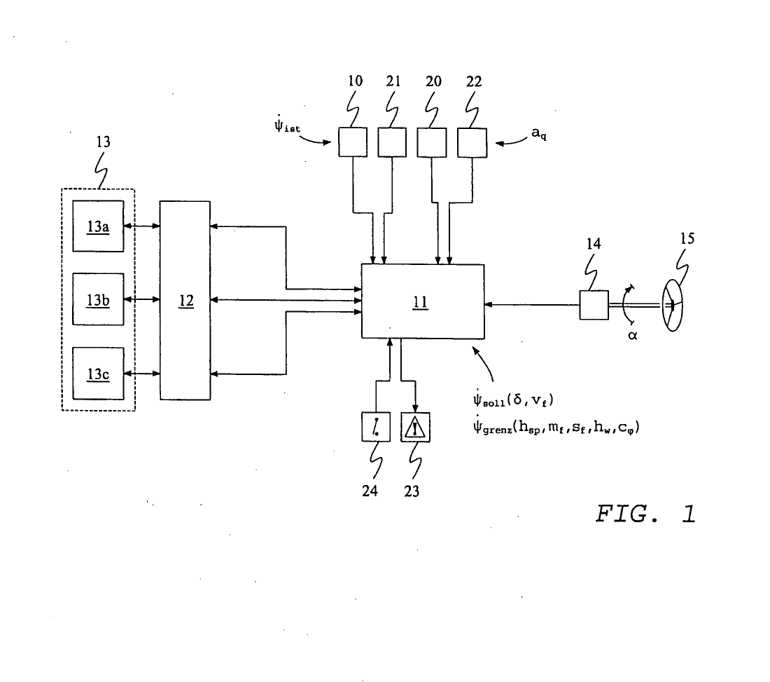

FIG. 1 illustrates schematically an exemplary embodiment of the device according to the invention for preventing roll in a vehicle. The device comprises a detection device 10 which determines an actual value \dot{ψ}_{actual} of a yaw rate variable describing the yaw rate of the vehicle, and an evaluation unit 11 which determines a setpoint value \dot{ψ}ₛₑₜₚₒᵢₙₜ of the yaw rate variable and a threshold value \dot{ψ}_{threshold} of the yaw rate variable that is suitable for limiting the setpoint value \dot{ψ}ₛₑₜₚₒᵢₙₜ for avoiding rollover of the vehicle. The detection device 10 is, for example, a yaw rate sensor situated in the vehicle which is operatively linked to the evaluation unit 11. There is also a control device 12, operatively linked to the evaluation unit 11, for controlling, independently of the driver, vehicle units 13 provided for influencing the longitudinal and/or transversal dynamics of the vehicle. The detection device 10, evaluation unit 11, and control device 12 are components of an electronic stability program (ESP) system present in the vehicle.

The vehicle units 13 are drive means 13a for providing propulsion which acts on the vehicle, and/or braking means 13b for braking the wheels of the vehicle, and/or steering means 13c for influencing the steering of the vehicle. The drive means 13a includes, among other components, the engine, transmission, and transmission coupling for the vehicle, whereas the braking means 13b includes wheel braking devices associated with the wheels of the vehicle. The braking means 13b is designed so that the wheels of the vehicle may each be braked independently. The steering means 13c is provided in a known manner for influencing a steering angle which can be set at the steerable wheels of the vehicle.

The evaluation unit 11 controls the vehicle units 13, based on a comparison between the determined actual value \dot{ψ}_{actual} of the yaw rate variable and the determined setpoint value \dot{ψ}ₛₑₜₚₒᵢₙₜ of the yaw rate variable, in such a way that the determined actual value \dot{ψ}_{actual} of the yaw rate variable assumes the determined setpoint value \dot{ψ}ₛₑₜₚₒᵢₙₜ of the yaw rate variable. In the event that the setpoint value \dot{ψ}ₛₑₜₚₒᵢₙₜ of the yaw rate variable exceeds the threshold value \dot{ψ}_{threshold} of the yaw rate variable, to avoid rollover of the vehicle the evaluation unit 11 limits the determined setpoint value \dot{ψ}ₛₑₜₚₒᵢₙₜ of the yaw rate variable to the determined threshold value \dot{ψ}_{threshold} of the yaw rate variable.

The setpoint value \dot{ψ}ₛₑₜₚₒᵢₙₜ of the yaw rate variable is determined by the evaluation unit 11 as a function of a determined steering angle variable δ which describes the steering angle which can be set at the steerable wheels of the vehicle, and/or as a function of a longitudinal speed variable v_{f} which describes the longitudinal speed of the vehicle, based on a single-track vehicle model.

To determine the steering angle variable δ, a steering angle sensor 14 is provided which detects the deflection α of a steering control 15 provided in the vehicle for driver-side influence of the steering angle, and converts the deflection to a corresponding signal that is sent to the evaluation unit 11. There are also wheel speed sensors 20 which detect the rotational speeds at the wheels of the vehicle and generate corresponding signals that are sent to the evaluation unit 11 for determining the longitudinal speed variable v_{f}.

According to the invention, the evaluation unit 11 determines the threshold value \dot{ψ}_{threshold} of the yaw rate variable as a function of a threshold value φ_{threshold} of a roll angle variable φ which describes a roll angle of the vehicle. In the present exemplary embodiment, the roll angle variable φ is the tipping angle of the vehicle which describes a rotation of the vehicle about a tipping axis oriented in the longitudinal direction of the vehicle. Of course, instead of the tipping angle any other roll angle variable φ may be used which describes a roll angle of the vehicle.

The threshold value φ_{threshold} of the roll angle variable φ is determined based on kinematic considerations. The evaluation unit 11 takes into account variables that characterize the load state and/or geometric characteristics and/or body characteristics of the vehicle. The load state of the vehicle is characterized, for example, by indicating the position of center of gravity and/or the mass of the vehicle. Accordingly, the variables that characterize the load state of the vehicle include a position of center of gravity variable hₛₚ which describes the location of the center of gravity of the vehicle, and/or a mass variable m_{f} which describes the mass of the vehicle. In the present case, the position of center of gravity variable hₛₚ should describe the height of the center of gravity of the vehicle relative to the roadway surface. With regard to with the geometric and/or body characteristics of the vehicle, primarily the track width, the position of center of roll, and the roll resistance of the body of the vehicle have a significant influence on the roll behavior of the vehicle. The variables that characterize the geometric characteristics of the vehicle therefore include a track width variable s_{f} which describes the track width of the vehicle, and/or a position of center of roll variable h_{w} which describes the location of the center of roll of the vehicle. In the present case, the position of center of roll variable h_{w} should describe the height of the center of roll of the vehicle. Lastly, the variables that characterize the body characteristics of the vehicle include a roll resistance variable c_{φ} which describes the roll resistance of the vehicle.

The evaluation unit 11 determines the position of the center of gravity variable hₛₚ and/or the mass variable m_{f} while the vehicle is traveling and/or before it starts to travel. These variables are determined as a function of variables that characterize the state of motion of the vehicle, and/or as a function of the temporal response of at least one of these variables. The variables that characterize the state of motion of the vehicle include a tipping angle variable which describes the tipping angle of the vehicle, and/or a pitch angle variable which describes the pitch angle of the vehicle. The tipping angle variable and/or the pitch angle is determined by evaluating the deflection paths which occur at the wheel suspension units of the vehicle, which are detected by appropriate deflection path sensors 21 which are operatively linked to the evaluation unit 11. The deflection path sensors 21 are generally present in vehicles equipped with pneumatic suspension.

The track width variable s_{f}, position of center of roll variable h_{w}, and roll resistance variable c_{φ} are generally invariant variables which are stored as fixed values in the evaluation unit 11.

As an alternative to the described determination of the position of center of gravity variable hₛₚ and/or the mass variable m_{f}, the device according to the invention is designed so that in each case a fixed, predetermined value for the position of center of gravity variable hₛₚ and/or the mass variable m_{f} is stored in the evaluation unit 11. The values stored in the evaluation unit 11 are specified in such a manner that even unfavorable load states are taken into account which cannot result in a rollover of the vehicle (“worst case”).

In the determination of the yaw rate variable, the evaluation unit 11 additionally or alternatively takes variables into account which characterize the transverse dynamics of the vehicle and which include a transverse acceleration variable a_{q} which describes the transverse acceleration acting on the vehicle. The transverse acceleration variable a_{q} is determined by means of a transverse acceleration sensor 22 provided in the vehicle, the signals from which are sent to the evaluation unit 11.

In the case of a roll-stable state, in which all wheels of the vehicle are in contact with the roadway surface, with consideration of conservation of angular momentum a differential equation is obtained:
θₓₓ·\ddot{φ}=m_{f}·(hₛₚ−h_{w})(a_{q}+g·φ)−c_{φ}·φ−d_{φ}·φ, (1.1)
where:
φ—roll angle variable (tipping angle)
θₓₓ—principal moment of inertia of the vehicle about the roll axis (tipping axis)
m_{f}—mass variable
hₛₚ—position of center of gravity variable
h_{w}—position of center of roll variable
a_{q}—transverse acceleration variable
g—acceleration of gravity variable
c_{φ}—roll resistance variable
d_{φ}—roll damping variable
   The roll damping variable d_{φ} describes the roll damping of the vehicle, which results from the damping characteristics of the wheel suspension units.

Assuming that in the case of a roll-stable state of the vehicle the roll angle variable φ takes on stationary values, \ddot{φ}=\dot{φ}=0, it follows from equation (1.1):

$$\begin{matrix}φ = \frac{{a}_{q}}{g} \cdot {φ}_{o} , \\ where & ( 1.2 ) \\ {φ}_{o} := \frac{1}{{k}_{φ} - 1} \\ and & ( 1.3 ) \\ {k}_{φ} := \frac{{c}_{φ}}{{m}_{f} \cdot g \cdot ( {h}_{sp} - {h}_{w} )} . & ( 1.4 )\end{matrix}$$

On the other hand, in a rolling state in which at least one of the inside cornering wheels of the vehicle no longer makes contact with the roadway surface, a differential equation is obtained, as follows:

$${θ}_{xx} \cdot \ddot{φ} = - {m}_{f} \cdot g \cdot ( \frac{{s}_{f}}{2} \cdot cos φ - {h}_{sp} \cdot sin φ ) + {m}_{f} \cdot {a}_{q} \cdot ( {h}_{sp} \cdot cos ϕ - \frac{{s}_{f}}{2} \cdot sin ϕ ) , \\ where \text{:} \\ {s}_{f} - track width variable \qquad ( 2.1 )$$

Assuming that in the case of a rolling state of the vehicle the roll angle variable φ and its change over time (i.e., time derivative) \dot{φ}, takes on stationary values, \ddot{φ}=0, it follows from equation (2.1):

$$ϕ = arctan ( \frac{\frac{{s}_{r}}{2 {h}_{sp}} - \frac{{a}_{q}}{g}}{1 + \frac{{s}_{f}}{2 {h}_{sp}} \frac{{a}_{q}}{g}} ) . \qquad ( 2.2 )$$

For small values of the roll angle variable φ, series expansion of equation (2.2) results in the following:

$$φ \approx \frac{\frac{{s}_{f}}{2 {h}_{sp}} - \frac{{a}_{q}}{g}}{1 + \frac{{s}_{f}}{2 {h}_{sp}} \frac{{a}_{q}}{g}} . \qquad ( 2.3 )$$

If equations (1.2) and (2.3) are each solved for the transverse acceleration variable a_{q}, then equated and finally solved for the roll angle variable φ, an equation of the form

$${φ}_{thres} \approx - \frac{{h}_{sp}}{{s}_{f}} ( 1 + {φ}_{0} ) + \sqrt{{( \frac{{h}_{sp}}{{s}_{f}} )}^{2}} {( 1 + {φ}_{0} )}^{2} + {φ}_{0} , \qquad ( 3.1 )$$

is obtained which indicates a threshold value φ_{threshold} of the roll angle variable φ which characterizes a defined transition between a roll-stable state and a rolling state of the vehicle.

To determine the threshold value \dot{ψ}ₜₕᵣₑₛ of the yaw rate variable according to equation (3.1), the position of center of gravity variable hₛₚ, the mass variable m_{f}, the track width variable s_{f}, the center of roll variable h_{w}, and the roll resistance variable c_{φ}, but not the transverse acceleration variable a_{q}, must be known:
φₜₕᵣₑₛ≡φₜₕᵣₑₛ(hₛₚ,m_{f},s_{f},h_{w},c_{φ}). (3.2)

Accordingly, the following equation then also applies for determining the threshold value \dot{ψ}ₜₕᵣₑₛ of the yaw rate variable:
ψₜₕᵣₑₛ≡ψₜₕᵣₑₛ(hₛₚ,m_{f},s_{f},h_{w},c_{φ}). (3.3)

If the position of center of gravity variable hₛₚ is unknown, there is an alternative approach for determining the threshold value φ_{threshold} of the roll angle variable φ. For this purpose, equations (1.2) and (2.3) are equated and then solved for the transverse acceleration variable a_{q}:

$${a}_{q} \approx - \frac{g \cdot {h}_{sp}}{{φ}_{0} \cdot {s}_{f}} ( 1 + {φ}_{0} ) + g \cdot \sqrt{{( \frac{{h}_{sp}}{{φ}_{0} \cdot {s}_{f}} )}^{2} {( 1 + {φ}_{0} )}^{2} + \frac{1}{{φ}_{0}}} . \qquad ( 3.4 )$$

Then equations (3.1) and (3.4) are each solved for the position of center of gravity variable hₛₚ, equated to one another, and solved for the threshold value φₜₕᵣₑₛ of the roll angle variable φ:

$${φ}_{thres} \approx \frac{1 - \frac{2 {h}_{w}}{{s}_{f}} \frac{{a}_{q}}{g}}{\frac{2 {c}_{φ}}{{m}_{f} \cdot g \cdot {s}_{f}} + \frac{2 {h}_{w}}{{s}_{f}} + \frac{{a}_{q}}{g}} \qquad ( {3.1}^{′} )$$

To determine the threshold value φₜₕᵣₑₛ of the roll angle variable φ according to equation (3.1′), the transverse acceleration variable a_{q}, mass variable m_{f}, track width variable s_{f}, position of center of roll variable h_{w}, and roll resistance variable c_{φ}, but not the position of center of gravity variable hₛₚ, must be known:
φₜₕᵣₑₛ≡φₜₕᵣₑₛ(a_{q},m_{f},s_{f},h_{w},c_{φ}) (3.2′)

Accordingly, the following equation then also applies for determining the threshold value \dot{ψ}ₜₕᵣₑₛ of the yaw rate variable:
ψₜₕᵣₑₛ≡ψₜₕᵣₑₛ(a_{q},m_{f},s_{f},h_{w},c_{φ}) (3.3′)

Graphically represented, the values of the roll angle variable φ span an n-dimensional array [symbol] ⁿ (n=5) which may be divided into two n-dimensional subarrays, of which a first subarray includes all values of the roll angle variable φ that result in a roll-stable state of the vehicle, whereas a second subarray includes all values of the roll angle variable φ in which the vehicle assumes a rolling state. The intersection of the two subarrays then represents the number of all possible solutions to equation (3.1) or (3.1′).

The threshold value \dot{ψ}ₜₕᵣₑₛ of the yaw rate variable is determined either directly from the determined threshold value φₜₕᵣₑₛ of the roll angle variable φ
\dot{ψ}ₜₕᵣₑₛ≡\dot{ψ}ₜₕᵣₑₛ(φₜₕᵣₑₛ), (3.5)
or by permitting a tolerance ±Δ_{φsafe} for the threshold value φₜₕᵣₑₛ of the roll angle variable φ:
\dot{ψ}ₜₕᵣₑₛ≡\dot{ψ}ₜₕᵣₑₛ(φₜₕᵣₑₛ)±Δ\dot{ψ}ₜₕᵣₑₛ(Δφₜₕᵣₑₛ) (3.6)

To indicate to the driver the presence of a critical roll situation, the evaluation unit 11 provides controllable driver information means 23 for sending optical and/or acoustic driver information.

The driver-side activation or deactivation of the device according to the invention is performed by use of a switch 24 provided in the vehicle.

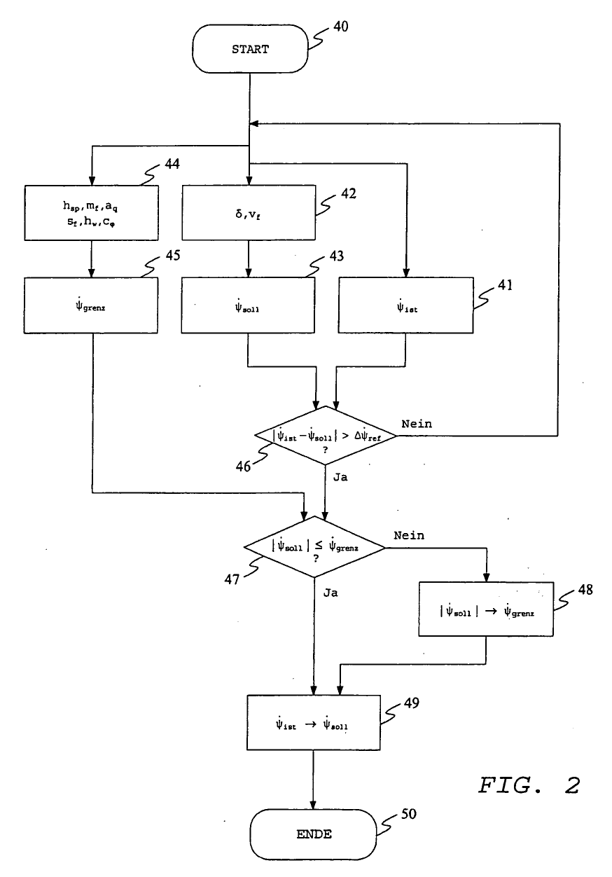

FIG. 2 shows an exemplary embodiment of the method according to the invention in the form of a flow diagram. The method is started in an initialization step 40, whereupon in a first main step 41 the actual value \dot{ψ}_{actual} of the yaw rate variable is determined. In parallel in a second main step 42 the steering angle variable δ and/or the longitudinal speed variable v_{f} is determined, so that later in a third main step 43 the setpoint value \dot{ψ}ₛₑₜₚₒᵢₙₜ of the yaw rate variable is determined based on the single-track vehicle model, as a function of the steering angle variable δ and/or the longitudinal speed variable v_{f}. Furthermore, in parallel in a fourth main step 44 the position of center of gravity variable hₛₚ and/or mass variable m_{f} and/or transverse acceleration variable a_{q} and/or track width variable s_{f} and/or position of center of roll variable h_{w} and/or roll resistance variable c_{φ} are determined or provided, so that in a subsequent fifth main step 45 the threshold value φ_{threshold} of the roll angle variable φ, and as a function thereof, once again the setpoint value \dot{ψ}ₛₑₜₚₒᵢₙₜ of the yaw rate variable, are determined.

In a sixth main step 46 the actual value \dot{ψ}_{actual} of the yaw rate variable determined in main step 41 is compared to the setpoint value \dot{ψ}ₛₑₜₚₒᵢₙₜ of the yaw rate variable determined in the third main step 43, and a check is made as to whether the absolute value of the difference of the setpoint value \dot{ψ}ₛₑₜₚₒᵢₙₜ of the yaw rate variable and the actual value \dot{ψ}_{actual} of the yaw rate variable exceeds a predetermined threshold value Δ\dot{ψ}_{ref}:
|\dot{ψ}ₛₑₜₚₒᵢₙₜ−\dot{ψ}_{actual}|>Δ\dot{ψ}_{ref}. (4.1)

If the condition specified by equation (4.1) is not satisfied, the method returns to main steps 41, 42, and 44 to begin anew with the determination of the actual value \dot{ψ}_{actual} of the yaw rate variable, the setpoint value \dot{ψ}ₛₑₜₚₒᵢₙₜ of the yaw rate variable, and the threshold value \dot{ψ}ₜₕᵣₑₛ of the yaw rate variable. Otherwise, the method is continued with a seventh main step 47, in which a further check is made as to whether the absolute value of the setpoint value \dot{ψ}ₛₑₜₚₒᵢₙₜ of the yaw rate variable determined in the third main step 43 is less than or equal to the threshold value \dot{ψ}ₜₕᵣₑₛ of the yaw rate variable determined in the fifth main step 45:
|\dot{ψ}ₛₑₜₚₒᵢₙₜ|≦\dot{ψ}ₜₕᵣₑₛ. (4.2)

If the condition specified by equation (4.2) is satisfied, in a subsequent ninth main step 49 the vehicle units 13 are controlled so that the actual value \dot{ψ}_{actual} of the yaw rate variable determined in the first main step 41 assumes the setpoint value \dot{ψ}ₛₑₜₚₒᵢₙₜ of the yaw rate variable determined in the third main step 43. The method is then ended in a final step 50.

On the other hand, if it is determined in the seventh main step 47 that the absolute value of the setpoint value \dot{ψ}ₛₑₜₚₒᵢₙₜ of the yaw rate variable determined in the third main step 43 exceeds the threshold value \dot{ψ}_{threshold} of the yaw rate variable determined in the fifth main step 45, in an eighth main step 48 the absolute value of the setpoint value \dot{ψ}ₛₑₜₚₒᵢₙₜ of the yaw rate variable determined in the third main step 43 is limited to the threshold value \dot{ψ}_{threshold} of the yaw rate variable determined in the fifth main step 45, whereupon in the ninth main step 49 the vehicle units 13 are controlled so that the actual value \dot{ψ}_{actual} of the yaw rate variable assumes the limited setpoint value \dot{ψ}ₛₑₜₚₒᵢₙₜ of the yaw rate variable. The method is then ended, likewise in the final step 50.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-18. (canceled)

19. Apparatus for preventing rollover of a vehicle, said apparatus comprising:
a detection device which determines an actual value of a yaw rate variable that describes the yaw rate of the vehicle;
an evaluation unit which determines a setpoint value of the yaw rate variable and a threshold value of the yaw rate variable that is suitable for limiting the setpoint value for avoiding rollover of the vehicle, and a control device for adjusting vehicle units to influence longitudinal and/or transverse dynamics of the vehicle; wherein,
the evaluation unit controls adjustment of the vehicle units, based on a comparison between the determined actual and setpoint values of the yaw rate variable, such that the determined actual value assumes the determined setpoint value; and
if the setpoint value of the yaw rate variable exceeds the threshold value of the yaw rate variable, to avoid rollover of the vehicle the evaluation unit limits the determined setpoint value of the yaw rate variable to the determined threshold value of the yaw rate variable;
wherein, the evaluation unit determines the threshold value of the yaw rate variable as a function of a threshold value of a roll angle variable which describes a roll angle of the vehicle.

20. The apparatus according to claim 19, wherein the threshold value of the roll angle variable determined by the evaluation unit characterizes a transition between a roll-stable state and a rolling state of the vehicle.

21. The apparatus according to claim 19, wherein the evaluation unit determines the setpoint value of the yaw rate variable as a function of at least one of i) a determined steering angle variable which describes the steering angle that can be set at the steerable wheels of the vehicle, and ii) a longitudinal speed variable which describes longitudinal speed of the vehicle.

22. The apparatus according to claim 19, wherein the evaluation unit determines the threshold value of the yaw rate variable as a function of variables that characterize at least one of the load state, geometric characteristics and body characteristics of the vehicle.

23. The apparatus according to claim 22, wherein the variables that characterize the load state of the vehicle include at least one of the position of the center of gravity variable which describes the spatial location of the center of gravity of the vehicle, and a mass variable which describes the mass of the vehicle.

24. The apparatus according to claim 22, wherein the variables that characterize the geometric characteristics of the vehicle include a track width variable which describes the track width of the vehicle, and/or a position of center of roll variable which describes the location of the center of roll of the vehicle.

25. The apparatus according to claim 22, wherein the variables that characterize the body characteristics of the vehicle include a roll resistance variable which describes the roll resistance of the body of the vehicle.

26. The apparatus according to claim 23, wherein the evaluation unit determines the position of the center of gravity variable and/or the mass variable while and/or before the vehicle starts to travel.

27. The apparatus according to claim 23, wherein the evaluation unit determines the position of the center of gravity variable and/or the mass variable as a function of variables that characterize the state of motion of the vehicle, and/or as a function of the temporal response of at least one of these variables.

28. The apparatus according to claim 27, wherein the variables that characterize the state of motion of the vehicle include at least one of a tipping angle variable which describes the tipping angle of the vehicle, and a pitch angle variable which describes the pitch angle of the vehicle.

29. The apparatus according to claim 23, wherein in each case a fixed, predetermined value for the position of the center of gravity variable and/or the mass variable is stored in the evaluation unit.

30. The apparatus according to claim 19, wherein the evaluation unit determines the threshold value of the roll angle variable as a function of variables that characterize transverse dynamics of the vehicle.

31. The apparatus according to claim 30, wherein the variables that characterize the transverse dynamics of the vehicle include a transverse acceleration variable which describes the transverse acceleration acting on the vehicle.

32. The apparatus according to claim 19, wherein the vehicle units comprise at least one of drive for providing propulsion which acts on the vehicle, braking apparatus for braking the wheels of the vehicle, and steering apparatus for influencing the steering of the vehicle.

33. The apparatus according to claim 32, wherein the braking apparatus is designed so that the wheels of the vehicle may each be braked independently.

34. The apparatus according to claim 19, wherein the detection device, evaluation unit, and control device are components of an electronic stability program present in the vehicle.

35. The apparatus according to claim 19, wherein:
the evaluation unit provides controllable driver information means for sending optical or acoustic driver information; and
the evaluation unit causes the optical or acoustic driver information to be sent in conjunction with the control of the vehicle units.

36. A method for preventing roll in a vehicle, comprising:
determining an actual value of a yaw rate variable describing the yaw rate of the vehicle;
determining a setpoint value of the yaw rate variable and a threshold value of the yaw rate variable;
comparing the determined actual value of the yaw rate variable and the determined setpoint value of the yaw rate variable;
controlling longitudinal or transversal dynamics of the vehicle in such a way as to cause the determined actual value of the yaw rate variable to assume the determined setpoint value of the yaw rate variable; and
if the setpoint value of the yaw rate variable exceeds the threshold value of the yaw rate variable, to avoid rollover of the vehicle, limiting the determined setpoint value of the yaw rate variable to the determined threshold value of the yaw rate variable;
wherein, the threshold value of the yaw rate variable is determined as a function of a threshold value of a roll angle variable which describes a roll angle of the vehicle.
